(19) United States
(12) Patent Application Publication
(10) Pub. No.: US 2017/0201121 A1
(43) Pub. Date: Jul. 13, 2017

(54) BATTERY CHARGING METHOD AND APPARATUS

(71) Applicants: Commissariat á I'Energie Atomique et aux Energies Alternatives, Paris (FR); BUBENDROFF SA, Attenschwiller (FR)

(72) Inventors: Henri ZARA, Le Bourget du Lac (FR); Franck VIAL, Paladru (FR); Jean-Marie KLEIN, Viviers du Lac (FR); Jean-Baptiste DESMOULIERE, Saint-Jean-D'Arvey (FR); Thomas FRITSCH, Hoenheim (FR)

(21) Appl. No.: 15/399,144

(22) Filed: Jan. 5, 2017

(30) Foreign Application Priority Data
Jan. 7, 2016 (FR) 1650116

(51) Int. Cl. H02J 7/35; H02J 7/00

(52) U.S. Cl. CPC H02J 7/355; H02J 7/0068; H02J 7/007

(57) ABSTRACT

A method of charging a battery of electric accumulators from the electric energy supplied by an electric generator, wherein the battery is chary to a first maximum state-of-charge in a first operating mode and to a second maximum state-of-charge, lower than the first maximum state-of-charge, in a second operating mode. The method includes switching from the first mode to the second mode when a first condition relative to the day length, or to the variation of the day length, is fulfilled and comprises switching from the second mode to the first mode when second conditions are fulfilled, the second conditions including determining that the day length becomes shorter than a first duration threshold and determining that a criterion determined from the environmental conditions of the electric generator or of the battery is fulfilled.

### CROSS-REFERENCE TO RELATED APPLICATION

This application claims the priority benefit of French patent application number 16/50116, filed on Jan. 7, 2016, the content of which is hereby incorporated by reference in its entirety to the maximum extent allowable by law.

### BACKGROUND

The present disclosure relates to a method of charging a battery of electric accumulators of an autonomous system.

### DISCUSSION OF THE RELATED ART

An autonomous system comprises an electric or electromechanical system, a battery of accumulators for the electric power supply of the electric or electromechanical system and an electric generator for the battery charge. An example of an autonomous system corresponds to an electric roller shutter powered by a battery charged by photovoltaic cells.

It is generally desirable for the capacity or battery life of the autonomous system to be as long as possible. For this purpose, it could be considered advantageous to charge the battery to a maximum as soon as the generator can supply electric energy to provide a maximum battery life in the case where the generator supplies little electric energy for a long period. It may however be preferably to limit the maximum state-of-charge of the battery when the battery temperature is too high. Indeed, the combination of a high state of-charge and of a high temperature accelerates the battery aging, be it at rest or in operation.

For certain applications, the battery of an autonomous system may be placed in an area which is not air-conditioned. In particular, when the battery is placed outdoors, the battery temperature may strongly vary during a year. As an example, during the summer, the battery temperature may temporarily strongly rise during the day.

It is known to modify the maximum state-of-charge of the battery according to the ambient temperature; or even to disconnect the battery from the generator. However, this type of regulation is a feedback control and not a feed forward control. It may not prevent, in certain cases, a degradation of the battery. Indeed, when the state-of-charge of the battery is already high and the ambient temperature increases, a control for decreasing the maximum state-of-charge of the battery has no effect, so that the battery will operate at a high temperature and with a high state-of-charge, and the battery lifetime may decrease.

### SUMMARY

An object of an embodiment is to overcome all or part of the disadvantages of the previously-described autonomous systems.

Another object of an embodiment is to increase the battery lifetime.

Another object of an embodiment is to increase the capacity of the autonomous system.

Another object of an embodiment is for the battery charge to automatically adapt to environmental conditions.

Thus, an embodiment provides a method of charging a battery of electric accumulators from the electric energy supplied by an electric generator, wherein the battery is charged to a first maximum state-of-charge in a first operating mode and to a second maximum state-of-charge, lower than the first maximum state-of-charge, in a second operating mode, the method comprising: switching from the first operating mode to the second operating mode when a first condition relative to the day length, or to the variation of the day length, is fulfilled, and comprising switching from the second operating mode to the first operating mode when second conditions are fulfilled., the second conditions comprising determining that the day length becomes shorter than a first duration threshold and determining that a criterion determined from environmental conditions of the electric generator or of the battery is fulfilled.

According to an embodiment, the criterion is determined from the general irradiance received by the electric generator or the battery r from the outer temperature of the battery.

According to an embodiment, the electric generator comprises photovoltaic cells.

According to an embodiment, the criterion is determined from the general irradiance received by the photovoltaic cells or from the outer temperature.

According to an embodiment, the first condition comprises determining whether the day length is equal to the day length at the winter solstice.

According to an embodiment, the first condition comprises determining whether the day length increases for several consecutive days.

According to an embodiment, the first condition comprises determining whether the day length decreases and then increases.

According to an embodiment, the first condition comprises determining whether the day length becomes shorter or longer than a second duration threshold lower than the first duration threshold.

According to an embodiment, the method comprises determining the duration for which the general irradiance received by the electric generator or the battery is greater than a general irradiance threshold or determining the duration for which the outer temperature of the battery is greater than a temperature threshold, and the criterion comprises determining whether said duration is longer than a third duration threshold.

According to an embodiment, the first duration threshold is equal to 12 hours to within 15 minutes.

According to an embodiment, the method comprises switching from the second operating mode to the first operating mode when it is successively determined that the day length becomes shorter than the first duration threshold and that the criterion is fulfilled.

According to an embodiment, the battery charge is further forbidden as long as the battery temperature is higher than a first temperature threshold.

According to an embodiment, the battery charge is antler forbidden as long as the battery temperature is lower than a second temperature threshold.

An embodiment also provides a system comprising an electric generator, a battery, a circuit for charging the battery from the electric energy supplied by the generator and a unit for controlling the charge circuit, the control unit being capable of controlling the battery charge to a first maximum state-of-charge in a first operating mode and to a second maximum state-of-charge, lower than the first maximum state-of-charge, in a second operating mode, the control unit being capable of switching from the first operating mode to the second operating mode when a first condition relative to the day length, or to the variation of the day length, is fulfilled and capable of switching from the second operating mode to the first operating mode when second conditions are fulfilled, the second conditions comprising determining that the day length becomes shorter than a first duration threshold and determining that a criterion determined from environmental conditions of the electric generator or of the battery is fulfilled.

According to an embodiment, the electric generator comprises photovoltaic cells.

The foregoing and other features and advantages will be discussed in detail in the following non-limiting description of specific embodiments in connection with the accompanying drawings.

### BRIEF DESCRIPTION OF THE DRAWINGS

FIG. 1 partially and schematically shows an embodiment of an autonomous system;

FIG. 2 is an operation chart of an embodiment of a first battery charge method implemented by the autonomous system shown in FIG. 1;

FIG. 3 is an operation chart of another embodiment of a second, battery charge method implemented by the autonomous system shown in FIG. 1;

FIG. 4 is a more detailed operation chart of an embodiment of a second battery charge method implemented by the autonomous system shown in FIG. 1; and

FIG. 5 is a more detailed operation chart of another embodiment of a second battery charge method implemented by the autonomous system shown in FIG. 1.

### DETAILED DESCRIPTION OF THE PRESENT EMBODIMENTS

The same elements have been designated with the same reference numerals in the different drawings. For clarity, only those elements which are useful to the understanding of the described embodiments have been shown and detailed. In particular, the structure of an electric accumulator of a battery of accumulators is well known and is not described in detail. In the following description, when reference is made to terms qualifying absolute positions, such as terms “front”, “back”, “top”, “bottom”, “left”, “right”, etc., or relative positions, such as terms “above”, “under”, “upper”, “lower”, etc., or to terms qualifying directions, such as terms “horizontal”, “vertical”, etc., it is referred to the orientation of the drawings. Unless otherwise specified, expressions “approximately”, “substantially”, and “in the order of” mean to within 10%, preferably to within 5%.

FIG. 1 shows an embodiment of an autonomous system 10 comprising:

an electric or electromechanical system 12;

at least one battery 14 of electric accumulators allowing the electric power supply of electric or electromechanical system 12;

an electric generator 16 for the charge of battery 14;

a charge circuit 18 connected between electric generator 16 and battery 14;

a unit 20 for controlling charge circuit 18;

a sensor of the temperature of battery 14 connected to control unit 20;

a circuit 24 for measuring the voltage across generator 16 and the current supplied by generator 16; and

a circuit 26 for measuring voltage across battery 14 and the current supplied by battery 14.

Electric or electromechanical system 12 may correspond to any type of system requiring an electric power supply. As an example, electric or electromechanical system 12 corresponds to an electric roller shutter, an electric gate, a motor-driven window, or a piece of street furniture requiring at electric power supply, for example, a pay-and-display machine or street lighting equipment.

Electric generator 16 may correspond to any type of electric power source. Electric generator 16 may correspond to a generating unit or the electric network. Preferably, electric generator 16 is capable of supplying electric energy from renewable energy, for example, solar energy, wind energy, hydraulic energy, or geothermal energy. As an example, electric generator 16 comprises photovoltaic cells capable of outputting a DC electric current and/or voltage when they receive an incident solar radiation, the photovoltaic cells being interconnected, in series or in parallel, via an electric circuit and capable of being arranged on one or a plurality of photovoltaic panels, the assembly of the interconnected photovoltaic cells being called photovoltaic power plant 16 in the following description. According to another example, electric generator 16 comprises at least one wind turbine or one hydraulic device.

Battery 14 may correspond to a battery of electric accumulators of any type, particularly a lithium battery, a metal nickel-hydride battery, or a lead-acid battery. The electric accumulators of battery 14 may be assembled in series and/or in parallel.

Control unit 20 may correspond to a dedicated circuit and/or may comprise a processor, for example, a microprocessor or a microcontroller, capable of executing instructions of a computer program stored in the memory.

Charge circuit 18 is a circuit interposed between electric generator 16 and battery 14. In the case where electric generator 16 comprises photovoltaic cells, charge circuit 18 may only correspond to a circuit preventing the discharge of battery 14 into the photovoltaic cells when the latter generate no electric energy. More generally, charge circuit 18 may be capable of converting the electric power supplied by generator 16 into electric energy capable of charging battery 14. Charge circuit 18 for example comprises a voltage convener, for example, a Buck-type converter.

Control unit 20 is capable of controlling charge circuit 18 to implement a charge method adapted to the specificities of battery 14. Control unit 20 is for example capable of implementing a maximum power point tracking method (MPPT). Control unit 20 is further capable of controlling charge circuit 18 to prevent the charge of battery 14 by electric generator 16.

According to an embodiment, temperature sensor 22 is arranged in contact with the accumulators of battery 14. According to an embodiment, a plurality of temperature sensors 22 are present and arranged in contact with the accumulators of battery 14 at different locations. The temperature of battery 14 may then correspond to the highest temperature from among the temperatures measured by the temperature sensors or to an average of the temperatures measured by the temperature sensors. According to another embodiment, temperature sensor 22 is capable of measuring the ambient temperature, that is, the temperature in the vicinity of battery 14 for example, more than 10 cm away from battery 14. Control unit 18 is then capable of estimating the temperature of battery 14 from the measured ambient temperature by using charts stored in the memory.

Processing unit 20 may be capable of determining the electric power supplied by generator 16 from the measurements of the voltage and of the intensity supplied by measurement circuit 24. Processing unit 20 is further capable of estimating the state-of-charge of battery 14, for example, by means of charts stored in the memory, from measurements of the temperature of battery 14 supplied by temperature sensor 22 and the voltage across battery 14 and the current supplied by battery 14 supplied by measurement circuit 26.

According to an embodiment, control unit 20 simultaneously implements two methods of controlling charge circuit 18.

According to an embodiment, the first control method aims at preventing any operation of charge of battery 14 only if the temperature of battery 14 is too high or too low to avoid a degradation of battery 14.

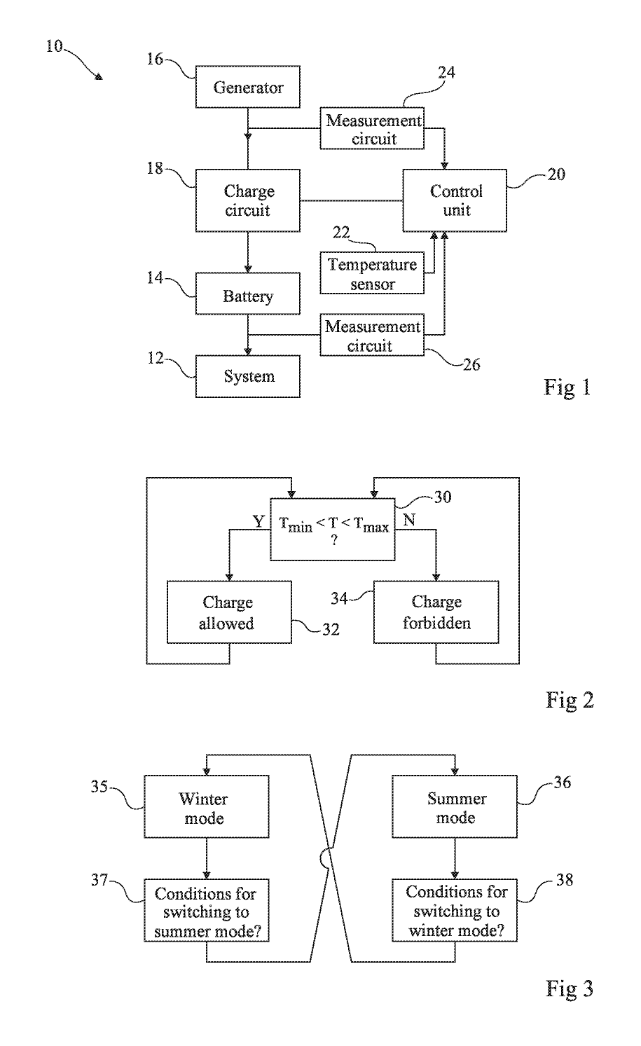

FIG. 2 shows a more detailed operation chart of an embodiment of the first control method.

At step 30, control unit 20 verifies whether the temperature of battery 14 is between a minimum temperature Tₘᵢₙ and a maximum temperature Tₘₐₓ. As an example, minimum temperature Tₘᵢₙ is equal to 0° C. As an example, maximum temperature Tₘₐₓ is in the range from 40° C. to 60° C., preferably from 45° C. to 50° C. If the temperature of battery 14 is between temperatures Tₘᵢₙ and Tₘₐₓ, the method carries on at step 32. If not, the method carries on at step 34.

At step 32, control unit 20 allows an operation of charge of battery 14. The method carries on at step 30.

At step 34, control unit 20 prevents any operation of charge of battery 14. The method carries on at step 30.

According to an embodiment, the second control method aims, for a battery charge operation, at selecting the maximum state-of-charge that battery 14 can reach from among a first value and a second value. The first value, preferably varying from 80% to 100%, for example, 100%, is selected during the period in the year when the ambient temperature around battery 14 is the lowest. Battery 14 is then said to be in winter operating mode. The second value, preferably varying from 60% to 70%, for example, 70%, is selected during the period of the year when the ambient temperature around battery 14 is the highest. Battery 14 is then said to be in summer operating mode.

FIG. 3 shows an operation chart of an embodiment of the second control method.

The second control method varies cyclically between the winter operating mode (step 35) and the summer operating mode (step 36). When first conditions are fulfilled (step 37), control unit 20 switches to the winter operating mode to the summer operating mode and when second conditions are fulfilled (step 38), control unit 20 switches from the summer operating mode to the winter operating mode.

According to an embodiment, unit 20 causes the switching from the summer operating mode to the winter operating mode at the winter solstice.

According, to an embodiment, unit 20 causes the switching from the summer operating mode to the winter operating mode when two successive criteria are fulfilled. The first criterion comprises determining that the autumnal equinox has been reached. The second criterion reflects the fact that the average electric power supplied by electric generator 16 has decreased and/or that risks of overheating of battery 14 have decreased. The second criterion can be determined from the environmental conditions of electric generator 16 or of battery 14. As an example, the second criterion is determined from the general irradiance received by electric generator 16 or, battery 14 or from the outer temperature or the battery temperature. The outer temperature may be measured on an electronic board, for example, or at the battery level. The second criterion may comprise determining, during several consecutive days, for example, 15 days, the duration for which the general irradiance received by the electric generator or the battery is greater than a general irradiance threshold or the duration for which the outer temperature or the battery temperature is higher, than a temperature threshold. The second criterion is fulfilled when the duration of strong general irradiance or the duration of high temperature decreases below a duration threshold. In the case where electric generator 16 comprises photovoltaic cells, the second criterion may comprise determining, for several consecutive days, for example, 15 days, the duration for which the general irradiance received by the photovoltaic cells exceeds a general irradiance threshold, called strong general irradiance threshold. The second criterion is fulfilled when the duration of strong general irradiance decreases below a duration threshold.

The general irradiance corresponds to the power of an electromagnetic radiation received by an object per surface area unit. According to an embodiment, the measured general irradiance is that of the useful spectrum of the sunlight received by the photovoltaic cells. In a given plane, for example, that of the photovoltaic panels comprising the photovoltaic cells, the general irradiance is the sum of three components:

the direct irradiance, which directly originates from the sun, this component being zero when the sun is hidden by clouds or by an obstacle;

the diffuse irradiance, which corresponds to the radiation received from the vault of heaven, except for direct radiation; and

the reflected irradiance, which corresponds to the radiation reflected by the ground and the environment, this component being zero on a horizontal plane.

The general irradiance may be determined from the measurement of the short-circuit current of the photovoltaic plant. This advantageously enables to increase the maximum state-of-charge of battery 14 sufficiently soon to ensure the proper operation of autonomous system 10 during the period of the year when the power generation by generator 16 is the lowest. In the case where electric generator 16 comprises no photovoltaic cells, control unit 20 may determine the general irradiance of the sunlight received by battery 14 by means of an adapted sensor.

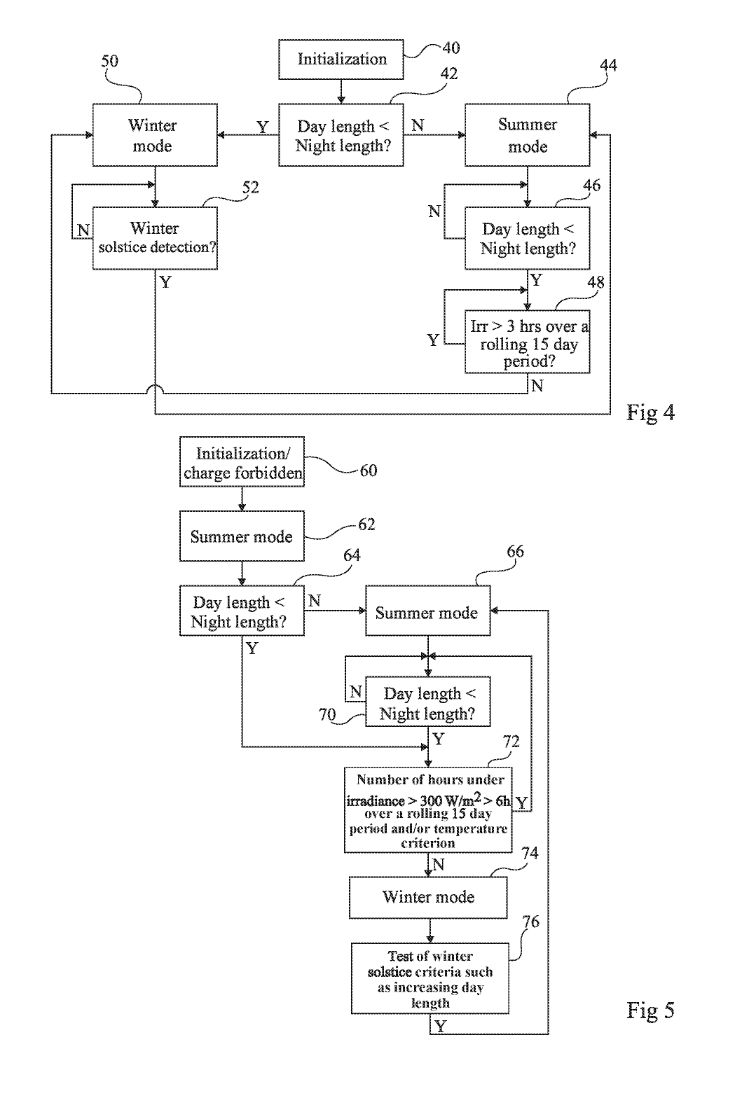

FIG. 4 sheds a mere detailed operation chart of an embodiment of the second control method.

Step 40 corresponds to an initialization step in which control unit is automatically placed at the first starting of autonomous system 10, for example, on powering-on of autonomous system 10. According, to an embodiment, at step 40, an operation of charge battery 40 is forbidden by unit 20. Indeed, at the starting of autonomous system 10, battery 14 is generally pre-charged, preferably between 60% and 70%. It is thus advantageous to wait for the determination of the winter or summer operating mode of the autonomous system before starting a charge operation to avoid charging battery 14 if this is not necessary. According to another embodiment, at step 40, an operation of charge of battery 14 is allowed according to an operating mode defined by default, for example, the summer operating mode. This advantageously enables, if battery 14 is partially discharged on powering-on of autonomous system 10, to start completing its charge to 70% without having to wait for a complete day/night cycle to carry out the test described hereafter at step 42. The method carries on at step 42.

At step 42, control unit 20 determines whether the autumnal equinox has been reached. According to an embodiment, control unit 20 determines whether the day length is shorter than a threshold, preferably 12 hours. According to an embodiment, when electric generator 16 comprises photovoltaic cells, the day length is equal to the duration for which the idle voltage of the photovoltaic power plant is higher than a threshold. The idle voltage of the photovoltaic power plant corresponds to the voltage across the photovoltaic power plant when no current flows between these terminals. The threshold may depend on the type of photovoltaic cells used and may correspond to a percentage of the nominal voltage of the photovoltaic power plant. According to an embodiment, when electric generator 16 comprises photovoltaic cells, the day length can be determined from the measurement supplied by an illumination sensor. According to an embodiment, when electric generator 16 comprises no photovoltaic cells, the day length can be determined from a signal supplied by a sunlight sensor connected to control unit 20. If the day length is substantially longer than 12 hours to within fifteen minutes, the method carries on at step 44 at which control unit 20 switches to the summer operating mode. If the day length is substantially shorter than 12 hours, the method carries on at step 50 at which control unit 20 switches to the winter operating mode.

At step 44, control unit 20 switches to the summer operating mode. The maximum charge rate of battery 14 is set to the maximum charge rate of the summer operating mode, preferably varying from 60% to 70%. Further, the method of charging battery 14, that is, the control of charge circuit 18 by control unit 20, may be specific in the summer operating mode. As an example, the maximum charge current of battery 14 may be limited. The summer operating mode carries on as long: as there is no switching to the winter mode and as long as no charge interruption has been requested by the first previously-described operating mode. The method carries on at step 46.

At step 46, control unit 20 determines whether the autumnal equinox has been reached, This may be performed in the same way as at step 42. If the day length is substantially longer than 12 hours, the method stays at step 46. If the day length is substantially shorter than 12 hours, the method carries on to step 48.

At step 48, in the case where electric generator 16 comprises photovoltaic cells, control unit 20 determines whether the duration of strong general irradiance received by photovoltaic cells 16 decreases below a duration threshold. It is advantageous for the duration of strong general irradiance to be determined on an analysis window of several consecutive days, preferably 15 days, to be representative of a general tendency of the variation of weather conditions. The general irradiance values are for example determined at regular intervals, preferably every 5 minutes. It is advantageous for the measurement step to be shorter than 15 minutes so that the determination of the duration of strong general irradiance is little modified by strong variations over short periods of the general irradiance, for example, when the sun is briefly hidden by clouds. The general irradiance values are stored in the memory by control unit 20. Control unit 20 determines the number of hours in the analysis window during which the general irradiance is greater than a threshold, preferably 300 W/m². Only the time periods which have elapsed above the threshold are taken into account if this number of hours is smaller than a threshold, for example, 3 hours, the method carries on at step 50 for a switching to the winter operating mode. If the number of hours thus determined is greater than the threshold, the method stays at step 48 and the number of hours is determined again by shifting the analysis window. The analysis window is thus a sliding window, preferably of 15 days, where the general irradiance measurements are performed. As an example, the number of hours for which the general irradiance is greater than a threshold is determined for each new measurement of the general irradiance with the general irradiance measurements performed during the analysis window, which ends with the last general irradiance measurement performed. According to another example, the determination of the number of hours during which the general irradiance is greater than a threshold is performed at regular intervals, preferably once a day, with the general irradiance measurements performed during the analysis window, which ends with the last general irradiance measurement performed. Advantageously, the switching from the summer operating mode to the winter operating mode is not performed as soon as the autumnal equinox has been reached. This enables to avoid increasing too soon the maximum charge rate of battery 14 when the weather conditions remain mild after the autumnal equinox and enables to increase the lifetime of battery 14.

At step 50, control unit 20 switches to the winter operating mode. The maximum charge rate of battery 14 is set to the maximum charge rate of the winter operating mode, preferably varying from 80% to 100%. Further, the method of charging battery 14, that is, the control of charge circuit 18 by control unit 20, may be specific in the winter operating mode. The winter operating mode carries on continuously as long as there is no switching to the summer operating mode and as long as there is no charge interruption requested by the first previously-described operating mode. The method carries on at step 52.

At step 52, control unit 20 determines whether the winter solstice has been reached. According to an embodiment, the winter solstice is considered to have been reached when control unit 20 determines that the day length, after having decreased, starts increasing again. According to an embodiment, control unit 20 stores in the memory the length of each day and determines the average day length for several successive days, preferably 5 days. According to another embodiment, the winter solstice is considered to have been reached when control unit 20 determines that the day length increases for several consecutive days, preferably 5 consecutive days. This advantageously enables, to avoid a false detection of the winter solstice in the case where a short day is erroneously determined, which may occur in the case of particularly unfavorable weather conditions or in the case where a screen is erroneously placed in front of the photovoltaic cells. Control unit 20 determines that the winter solstice has been reached when the average day length increases after having decreased. If the winter solstice has not been reached, the method remains at step 52 and the determination of the average day length is performed on the next day. If the winter, solstice has been reached, the method carries on at step 44 for a switching to the summer operating mode. The fact of switching sufficiently soon to the summer operating mode advantageously enables to obtain a decrease in the state-of-charge of the 14 which may take several months, before the arrival of summer temperatures. According to another embodiment, particularly according to the envisaged application, another day than the winter solstice may be considered at step 52. As an example, control unit 20 may determine whether the day length decreases below a threshold, which corresponds to a date prior to the winter solstice, or whether the day length increases above a threshold, which corresponds to a date subsequent to the winter solstice.

At the end of a ban on the charge of battery 14, resulting from the implementation of the first previously-described control method, the second control method may carry on at the step during which the charge had been forbidden.

Advantageously, the implementation of the second embodiment does not require a determination of the date of the day by processing unit 20. The determination of the operating mode of the autonomous system is automatically performed on starting thereof.

According, to an embodiment, control unit 20 may further determine whether, over a control duration of several months, for example, one year, the operating conditions of electric generator 16 are unfavorable, to maintain the state-of-charge of the battery in the order of 100% even in the summer operating mode. This advantageously enables to guarantee that battery 14 is sufficiently charged during the next switching to the winter operating mode. According to an embodiment, when electric generator 16 comprise photovoltaic cells, the determination of the unfavorable operating conditions of electric generator 16 may correspond to a lack of sunshine on the photovoltaic cells. This can be determined by control unit 20 from the measurement of the general irradiance received by the photovoltaic cells. According to an embodiment, it may be determined that the operating conditions of electric generator 16 are unfavorable when the temperature of battery 14 does not exceed maximum temperature Tₘₐₓ over the control period.

FIG. 5 shows a more detailed operation chart of another embodiment of the second control method.

Step 60 corresponds to an initialization state in which control unit 20 is automatically placed at the first starting of autonomous system 10, for example, on powering-on of autonomous system 10. Step 60 also corresponds to the step where the second control method can be carried on at the end of a ban on the charge of battery 14 resulting from the implementation of the first previously-described control method. The method carries on at step 62.

At step 62, control unit 20 switches to the summer operating mode as previously described for step 44. The method carries on at step 64.

At step 64, control unit 20 determines whether the autumnal equinox has been reached. This may be performed as previously described at step 42 or 44, for example, by determining whether the day length is substantially shorter than the night length, for example, between 11 h 45 and 12 h 15. If the day length is substantially longer than 12 hours, the method carries on at step 66. If the day length is substantially shorter than 12 hours, the method carries on at step 72.

At step 66, control unit 20 switches to the summer operating mode as previously described for step 44. The method carries on at step 70.

At step 70, control unit 20 determines whether the autumnal equinox has been reached. This may be performed in the same way as at step 64. If the day length is substantially greater than 12 hours, the method remains at step 70. If the day length is substantially shorter than 12 hours, the method carries on at step 72.

At step 72, control unit 20 determines whether the duration of strong general irradiance received by the autonomous system decreases below a duration threshold. This may be performed as previously described at step 48. If this duration is shorter than a threshold, the method carries on at step 74 for a switching to the winter operating mode. If the number of hours thus determined is greater than the threshold, the method carries on at step 70.

At step 74, control unit 30 switches to the winter operating mode as previously described for step 50. The method carries on at step 76.

At step 76, control unit 20 determines whether the winter solstice has been reached. This may be performed as previously described at step 52. If the winter solstice has not been reached, the method remains at step 76 and control unit 20 determines on the next day whether the winter solstice has been reached, if the winter solstice has been reached, the method carries on at step 66 for a switching to the summer operating mode.

Specific embodiments have been described. Various alterations, modifications, and improvements will occur to those skilled in the art. In particular, although in the previously-described embodiments, control unit 20 is capable of operating according to two successive operating modes over one years it should be clear that more than two successive operating modes may be provided over one year, a different maximum state-of-charge being associated with each operating mode.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. A method of charging a battery of electric accumulators from the electric energy supplied by an electric generator, wherein the battery is charged to a first maximum state-of-charge in a first operating mode and to a second maximum state-of-charge, lower than the first maximum state-of-charge, in a second operating mode, the method comprising switching from the first operating mode to the second operating mode when a first condition relative to the day length, or to the variation of the day length, is fulfilled, and comprising switching from the second operating mode to the first operating mode when second conditions are fulfilled, the second conditions comprising determining that the day length becomes shorter than a first duration threshold and determining that a criterion determined from the environmental conditions of the electric generator or of the battery is fulfilled.

2. The method of claim 1, wherein the criterion is determined from the general irradiance received by the electric generator or the battery or from the outer temperature of the battery.

3. The method of claim 1, wherein the electric generator comprises photovoltaic cells.

4. The method of claim 3, wherein the criterion is determined from the general irradiance received by the photovoltaic cells or from the outer temperature.

5. The method of claim 1, wherein the first condition comprises determining whether the day length is equal to the day length at the winter solstice.

6. The method of claim 1, wherein the first condition comprises determining whether the day length increases for several consecutive days.

7. The method of claim 1, wherein the first condition comprises determining whether the day length increases and then decreases.

8. The method of claim 1, wherein the first condition comprises determining whether the day length becomes shorter or longer than a second duration threshold lower than the first duration threshold.

9. The method of claim 1, comprising determining the duration for which the general irradiance received by the electric generator or the battery greater than a general irradiance threshold or determining the duration for which the outer temperature of the battery is higher than a temperature threshold, and wherein the criterion comprises determining whether said duration is longer than a third duration threshold.

10. The method of claim 1, wherein the first duration threshold is equal to 12 hours, to within 15 minutes.

11. The method of claim 1, comprising switching from the second operating mode to the first operating mode when it is successively determined that the day length becomes shorter than the first duration threshold and that the criterion is fulfilled.

12. The method of claim 1, wherein the charge of the battery is further forbidden as long as the battery temperature is higher than a first temperature threshold.

13. The method of claim 1, wherein the charge of the battery is further forbidden as long as the battery temperature is lower than a second temperature threshold.

14. A system comprising an electric generator, a battery, a circuit charging the battery from the electric energy supplied by the generator, and a unit for controlling the charge circuit, the control unit being capable of controlling the charge of the battery to a first maximum state-of-charge in a first operating mode and to a second maximum state-of-charge, lower than the first maximum state-of-charge, in a second operating mode, the control unit being capable of switching from the first operating mode to the second operating mode when a first condition relative to the day length, or to the variation of the day length, is fulfilled, and capable of switching from the second operating mode to the first operating mode when second conditions are fulfilled, the second conditions comprising determining that the day length becomes shorter than a first duration threshold and determining that a criterion determined from the environmental conditions of the electric generator or of the battery is fulfilled.

15. The method of claim 14, wherein the electric generator comprises photovoltaic cells.
